(19) United States
(12) Patent Application Publication
(10) Pub. No.: US 2024/0192308 A1
(43) Pub. Date: Jun. 13, 2024

(54) DATA-AIDED RADAR SENSING

(71) Applicant: Lenovo (Singapore) Pte. Ltd., New Tech Park (SG)

(72) Inventors: Seyedomid Taghizadeh Motlagh, Oberursel (DE); Ankit Bhamri, Rödermark (DE); Ali Ramadan Ali, Kraiburg am Inn (DE); Karthikeyan Ganesan, Kronberg im Taunus (DE); Sher Ali Cheema, Ilmenau (DE); Robin Thomas, Bad Nauheim (DE)

(21) Appl. No.: 18/551,175

(22) PCT Filed: Mar. 18, 2022
(86) PCT No.: PCT/IB2022/052499

§ 371 Date: Sep. 18, 2023

Related U.S. Application Data
(60) Provisional application No. 63/162,900, filed on Mar. 18, 2021.

(51) Int. Cl. G01S 7/00; G01S 7/02; G01S 13/00

(52) U.S. Cl. CPC G01S 7/006; G01S 7/0232; G01S 7/0235; G01S 13/003

(57) ABSTRACT

Various aspects of the present disclosure relate to data-aided radar sensing. One apparatus is configured to receive a first configuration comprising an indication of at least one set of time-frequency resources for sensing, receive a second configuration comprising an indication of a type of sensing to perform on the at least one set of time-frequency resources, perform sensing according to the first configuration and the second configuration, and transmit a report that indicates one or more sensing measurements based on the performed sensing.

### CROSS-REFERENCE TO RELATED APPLICATIONS

This application claims the benefit of U.S. Provisional Patent Application No. 63/162,900, entitled “DATA-AIDED RADAR SENSING” and filed on Mar. 18, 2021, for Seyedomid Taghizadeh Motlagh, et al., which is incorporated herein by reference.

### FIELD

The subject matter disclosed herein relates generally to wireless communications and more particularly relates data-aided radar sensing.

### BACKGROUND

In wireless networks, joint communication and radar sensing in the context of cellular communication networks finds various applications related to mobility monitoring and dynamic blockage detection for beam managements. Nevertheless, performing the radar sensing tasks via dedicated resources may increase the resources required for sensing and signaling.

### BRIEF SUMMARY

Disclosed are solutions for data-aided radar sensing. The solutions may be implemented by an apparatus, systems, methods, or computer program products.

In one embodiment, a first apparatus includes a transceiver that receives, from a second network node, a first configuration comprising an indication of at least one set of time-frequency resources on which the first network node is to perform at least one of a sensing measurement and a sensing measurement jointly with reception of one of data and control information and receives, from the second network node, a second configuration comprising an indication of a sensing measurement type to be applied on the at least one set of time-frequency resources identified with sensing. In one embodiment, the first apparatus includes a processor that conducts sensing measurements according to the first and second configurations. In one embodiment, the transceiver transmits a report from the conducted sensing measurements to the second network node.

In one embodiment, a first method receives, from a second network node, a first configuration comprising an indication of at least one set of time-frequency resources on which the first network node is to perform at least one of a sensing measurement and a sensing measurement jointly with reception of one of data and control information and receives, from the second network node, a second configuration comprising an indication of a sensing measurement type to be applied on the at least one set of time-frequency resources identified with sensing. In one embodiment, the first method conducts sensing measurements according to the first and second configurations. In one embodiment, the first method transmits a report from the conducted sensing measurements to the second network node.

In one embodiment, a second apparatus includes a transceiver that transmits, to a first network node, a first configuration comprising an indication of at least one set of time-frequency resources on which the first network node is to perform at least one of a sensing measurement and a sensing measurement jointly with reception of one of data and control information, transmits, to the first network node, a second configuration comprising an indication of a sensing measurement type to be applied on the at least one set of time-frequency resources identified with sensing, and receives, from the first network node, a report from the conducted sensing measurements.

In one embodiment, a second method transmits, to a first network node, a first configuration comprising an indication of at least one set of time-frequency resources on which the first network node is to perform at least one of a sensing measurement and a sensing measurement jointly with reception of one of data and control information, transmits, to the first network node, a second configuration comprising an indication of a sensing measurement type to be applied on the at least one set of time-frequency resources identified with sensing, and receives, from the first network node, a report from the conducted sensing measurements.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for data-aided radar sensing;

FIG. 2 is a diagram of a beam-management procedure in NR;

FIG. 3 is a diagram of a transmit and echo pulse time domain representation;

FIG. 4 is a diagram of different BWP configurations for sensing;

FIG. 5 is a diagram of various link scenarios for joint communication and sensing;

FIG. 6 is a diagram illustrating one embodiment of a NR protocol stack;

FIG. 7 is a block diagram illustrating one embodiment of a user equipment apparatus that may be used for data-aided radar sensing;

FIG. 8 is a block diagram illustrating one embodiment of a network apparatus that may be used for data-aided radar sensing; and

FIG. 9 is a flowchart diagram illustrating one embodiment of a method for data-aided radar sensing.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for data-aided radar sensing. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Joint communication and radar sensing in the context of cellular communication networks, finds various applications related to mobility monitoring and dynamic blockage detection for beam managements. Nevertheless, performing the radar sensing tasks via dedicated resources may increase the resources required for sensing and signaling.

In this disclosure, solutions are presented to enable radar sensing jointly with the data/control communication, where the properly established data/control links are also utilized for the purpose of blockage/movement monitoring based on sensing. The solutions cover various embodiments, including:
enabling advanced sensing features to facilitate sensing in parallel with data/control communication within the new radio (“NR”) (and beyond) framework;
identifying and establishing proper links/beams for data/control-aided radar sensing tasks; and
waveform adjustment for joint communication and radar sensing.

One embodiment includes new sensing modes that are defined to enable sensing gains from the communication links, including:
addition of the sensing modes to the UL and DL communication, via slot format indicator or dedicated UE signaling;
enabling configuration for different levels of sensing requirements to enable sensing scheduling in different nodes with different capabilities;
enabling sensing outside of the permissible communication resources;
sensing outside of the assigned time resources; and
sensing bandwidth part (“BWP”) and configuration of a dedicated BWP for sensing or extension of an active BWP operation for the purpose of sensing;

Another embodiment includes procedures for determination of the proper links to be monitored.

Another embodiment includes procedures for the adjustment/scheduling of communication and sensing parameters.

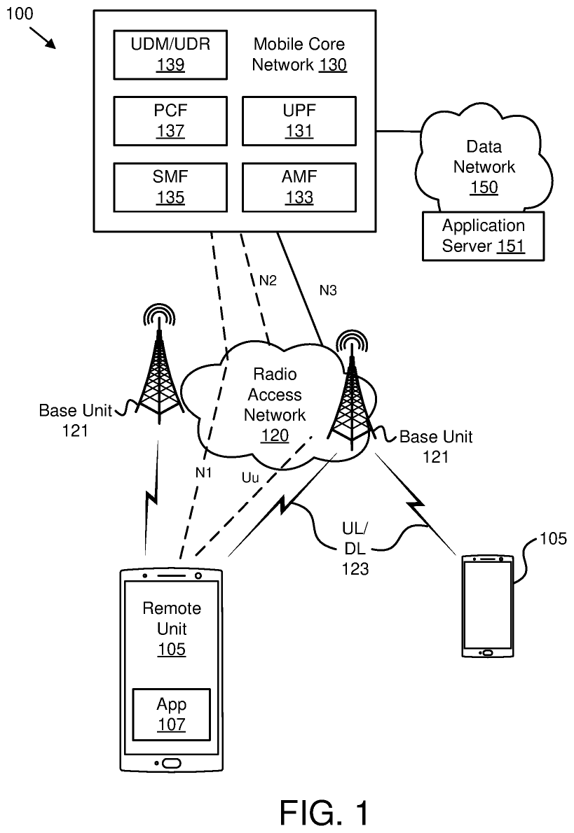

FIG. 1 depicts a wireless communication system 100 supporting data-aided radar sensing, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VOIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as ““attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QOS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) 136, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (DN), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

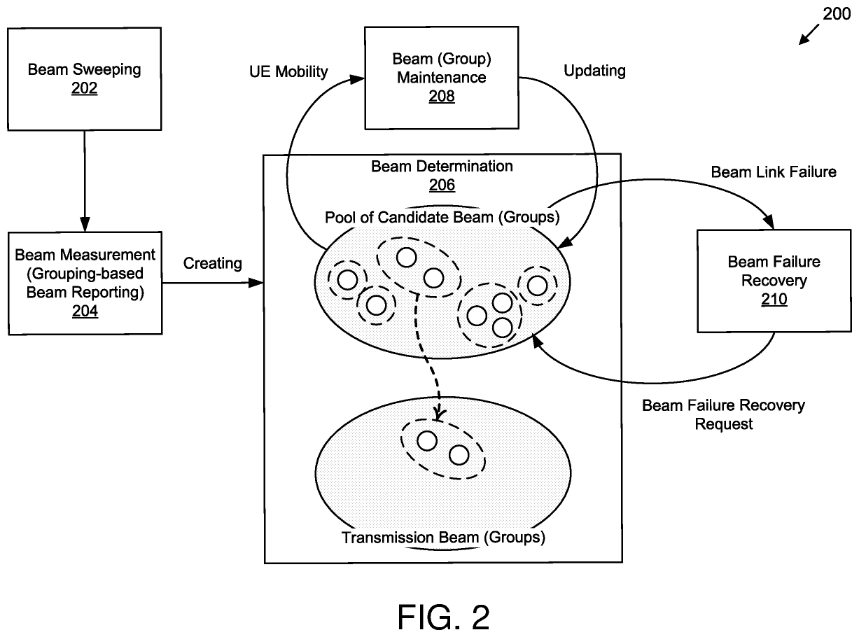

Regarding beam-management in NR Rel-15/16 (e.g., as discussed in Digital Object Identifier 10.1109/ACCESS.2019.2963514, titled “Beam Management in Millimeter-Wave Communications for 5G and Beyond,”), beam-management procedures in 3GPP NR may be summarized as follows:
Beam management, as shown in FIG. 2, is defined as a set of Layer 1/2 procedures to acquire and maintain a set of beam pair links e.g., a beam used at transmit-receive point(s) (“TRP(s)”) for base station (“BS”) side paired with a beam used at a UE. The beam pair links can be used for downlink (“DL”) and uplink (“UL”) transmission/reception. In one embodiment, the beam management procedures include at least the following aspects:
   Beam sweeping 202: operation of covering a spatial area, with beams transmitted and/or received during a time interval in a predetermined way;
   Beam measurement 204: for TRP(s) or a UE to measure characteristics of received beamformed (“BF”) signals;
   Beam reporting 204: for a UE to report information of BF signal(s) based on beam measurement;
   Beam determination 206: for TRP(s) or a UE to select its own Tx/Rx beam(s);
   Beam maintenance 208: for TRP(s) or a UE to maintain the candidate beams by beam tracking or refinement to adapt to the channel changes due to UE movement or blockage; and
   Beam recovery 210: for UE to identify new candidate beam(s) after detecting beam failure and subsequently inform TRP of beam recovery request with information of indicating the new candidate beam(s).

Regarding UL beam-management in NR Rel-15/16, in one embodiment, e.g., according to 3GPP TS 38.214, two transmission schemes, codebook-based transmissions and non-codebook based transmissions, are supported for physical uplink shared channel (“PUSCH”). For PUSCH transmission(s) dynamically scheduled by an UL grant in a downlink control information (“DCI”), a UE may, upon detection of a physical downlink control channel (“PDCCH”) with a configured DCI format 0_0 or 0_1, transmit the corresponding PUSCH as indicated by the DCI.

For PUSCH scheduled by DCI format 0_0 on a cell, in one embodiment, the UE transmits PUSCH according to the spatial relation, if applicable, corresponding to the physical uplink control channel (“PUCCH”) resource with the lowest identity (“ID”) within the active UL BWP of the cell, and the PUSCH transmission is based on a single antenna port. A spatial setting for a PUCCH transmission may be provided by a higher layer parameter PICCH-SpatialRelationInfo if the UE is configured with a single value for the higher layer parameter PUCCH-SpatialRelationInfold; otherwise, if the UE is provided with multiple values for the higher layer parameter PUCCH-SpatialRelationInfo, the UE determines a spatial setting for the PUCCH transmission based on a received PUCCH spatial relation activation/deactivation medium access control (“MAC”) control element (“CE”), e.g., as described in 3GPP TS 38.321. The UE, in one embodiment, applies a corresponding setting for a spatial domain filter to transmit PUCCH three milliseconds after the slot where the UE transmits HARQ-ACK information with an ACK value that corresponds to a physical downlink shared channel (“PDSCH”) reception providing the PICCH-SpatialRelationInfo.

For codebook-based transmission, in one embodiment, PUSCH can be scheduled by DCI format 0_0 or DCI format 0_1. If a PUSCH is scheduled by DCI format 0_1, in one embodiment, the UE determines its PUSCH transmission precoder based on sounding reference signal (“SRS”) resource indicator (“SRI”), transmit precoder matrix indicator (“TPMI”), and the transmission rank from the DCI, given by DCI fields of SRI and precoding information and number of layers, e.g., in subclause 7.3.1.1.2 of 3GPP TS 38.212. The TPMI, in one embodiment, is used to indicate the precoder to be applied over the antenna ports {0 . . . v−1} and that corresponds to the SRS resource selected by the SRI (unless a single SRS resource is configured for a single SRS-ResourceSet set to ‘codebook’).

The transmission precoder, in one embodiment, is selected from the uplink codebook that has several antenna ports equal to a higher layer parameter nrofSRS-Ports in SRS-Config, e.g., as defined in Subclause 6.3.1.5 of 3GPP TS 38.211. When the UE is configured with the higher layer parameter txConfig set to ‘codebook’, in one embodiment, the UE is configured with at least one SRS resource. The indicated SRI in slot n is associated with the most recent transmission of SRS resource identified by the SRI, where the SRS resource is prior to the PDCCH carrying the SRI before slot n. In one embodiment, the UE determines its codebook subsets based on TPMI and upon the reception of a higher layer parameter codebookSubset in PUSCH-Config, which may be configured with ‘fully AndPartialAndNonCoherent’, or ‘partialAndNonCoherent’, or ‘nonCoherent’ depending on the UE capability. The maximum transmission rank may be configured by the higher parameter maxRank in PUSCH-Config.

For non-codebook based transmission, PUSCH can be scheduled by DCI format 0_0 or DCI format 0_1. The UE can determine its PUSCH precoder and transmission rank based on the wideband SRI when multiple SRS resources are configured in an SRS resource set with higher layer parameter usage in SRS-ResourceSet set to ‘nonCodebook’, where the SRI is given by the SRS resource indicator in DCI format 0_1, e.g., according to subclause 7.3.1.1.2 of 3GPP TS 38.212 and only one SRS port is configured for each SRS resource. The indicated SRI in slot n is associated with the most recent transmission of SRS resource(s) identified by the SRI, where the SRS transmission is prior to the PDCCH carrying the SRI before slot n.

In one embodiment, the UE shall perform one-to-one mapping from the indicated SRI(s) to the indicated DM-RS ports(s) given by DCI format 0_1 in increasing order.

In Rel-16 3GPP NR, for example, for PUSCH scheduled by DCI format 0_0 on a cell, if the higher layer parameter enableDefaultBeamPIForPUSCH0_0 is set ‘enabled’, the UE is not configured with PUCCH resources on the active UL BWP and the UE is in radio resource control (“RRC”) connected mode, the UE shall transmit PUSCH according to the spatial relation, if applicable, with a reference to the RS with ‘QCL-Type-D’ corresponding to the quasi co-located (“QCL”) assumption of the control resource set (“CORESET”) with the lowest ID. For PUSCH scheduled by DCI format 0_0 on a cell, if the higher layer parameter enableDefaultBeamPIForPUSCH0_0 is set ‘enabled’, the UE may be configured with PUCCH resources on the active UL BWP where all the PUCCH resource(s) are not configured with any spatial relation and the UE is in RRC connected mode, the UE may transmit PUSCH according to the spatial relation, if applicable, with a reference to the reference signal (“RS”) with ‘QCL-Type-D’ corresponding to the QCL assumption of the CORESET with the lowest ID in case CORESET(s) are configured on the component carriers (“CC”).

According to 3GPP Rel-16 TS 38.214, in one embodiment, Rel-16 NR supports a MAC CE based spatial relation update for aperiodic SRS per resource level and a default UL beam for an SRS resource for latency and overhead reduction in UL beam management.

Regarding DL beam-management in NR Rel-15/16, for CSI reporting, one possibility to handling CSI reporting feedback for beam management is to use group-based beam reporting. However, due to no association with TRPs, the benefit is only limited to reduce overhead from feedback point of view and TRP-based beam management cannot benefit much. According to section 5.2.1.4 of 3GPP TS 38.214 (v16.0.0), the following is specified in terms of CSI reporting:

In one embodiment, if the UE is configured with a CSI-ReportConfig with the higher layer parameter reportQuantity set to ‘cri-RSRP’ or ‘ssb-Index-RSRP’,
if the UE is configured with the higher layer parameter groupBasedBeamReporting set to ‘disabled’, the UE is not required to update measurements for more than 64 channel-state information reference symbol (“CSI-RS”) and/or SSB resources, and the UE shall report in a single report nrofReportedRS (higher layer configured) different CSI-RS resource indicator (“CRI”) or SS block resource indicator (“SSBRI”) for each report setting.
if the UE is configured with the higher layer parameter groupBasedBeamReporting set to ‘enabled’, the UE is not required to update measurements for more than 64 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.

If the UE is configured with a CSI-ReportConfig with the higher layer parameter reportQuantity set to ‘cri-SINR’ or ‘ssb-Index-SINR’,
if the UE is configured with the higher layer parameter groupBasedBeamReporting set to ‘disabled’, the UE shall report (in a single report) nrofReportedRSForSINR (higher layer configured) different CRI or SSBRI for each report setting.
if the UE is configured with the higher layer parameter groupBasedBeamReporting set to ‘enabled’, the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.

Regarding QCL assumptions, according to one embodiment, there is a QCL type e.g., qcl-typeD for spatial relation between the source RS and target RS. This means that a single source to single target beam association may be established. However, as the frequency becomes higher, the number of beams could become higher, and therefore, more coarse association could be considered to cover wider areas. Also, from a transmission configuration indicator (“TCI”) indication point of view, up to two TCI states corresponding to two TRPs may be indicated, e.g., according to Rel. 16. However, this may still be limited when there could be possibly higher number of TRPs for FR2 and beyond. According to section 5.1.5 of 3GPP TS 38.214 (v16.0.0), for instance, the following is specified in terms of QCL assumptions:
The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-co-location relationship between one or two downlink reference signals and the DM-RS ports of the PDSCH, the DM-RS port of PDCCH or the CSI-RS port(s) of a CSI-RS resource. The QCL relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The QCL types corresponding to each DL RS are given by the higher layer parameter qcl-Type in QCL-Info and may take one of the following values:
   ‘QCL-TypeA’: {Doppler shift, Doppler spread, average delay, delay spread}
   ‘QCL-TypeB’: {Doppler shift, Doppler spread}
   ‘QCL-TypeC’: {Doppler shift, average delay}
   ‘QCL-TypeD’: {Spatial Rx parameter}
The UE receives an activation command, e.g., as described in clause 6.1.3.14 of TS 38.321 or in clause 6.1.3.x of TS 38.321, used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.
When a UE supports two TCI states in a codepoint of the DCI field ‘Transmission Configuration Indication’, the UE may receive an activation command, e.g., as described in clause 6.1.3.x of TS 38.321, the activation command is used to map up to 8 combinations of one or two TCI states to the codepoints of the DCI field ‘Transmission Configuration Indication’. The UE is not expected to receive more than 8 TCI states in the activation command.
When the UE transmits a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ} where μ is the subcarrier spacing (“SCS”) configuration for the PUCCH. If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to ‘QCL-TypeA’, and when applicable, also with respect to ‘QCL-TypeD’.

As an overview of radar sensing technologies, communication and radar technologies have been traditionally deployed as separate/independent systems each with a separate waveform. There are, however, use cases such as the automotive, smart factory, medical monitoring, etc., where joint radio communications and radar sensing using the same waveform are considered beneficial for efficient usage of the RF spectrum as well usage of the same hardware to perform high data rate communications and precise ranging. Radar systems can be classified into the following categories:
Monostatic radars: A radar system in which the transmitter and receiver are collocated.
Bistatic radar: A radar system that comprises of a transmitter and receiver that are separated by a distance comparable to the expected target distance.
Multistatic radar: A radar system which includes multiple spatially diverse monostatic radar or bistatic radar components within an overlapping coverage area.

Radar signals are characterized by pulses that are modulated onto an RF carrier and are used to detect single/multiple objects that can be resolved in the time domain. In a basic scenario, for a single reflector, a pulse with measured round-trip time t allows the range (R) with respect to the object to be calculated as:

$$R = \frac{ct}{2}$$

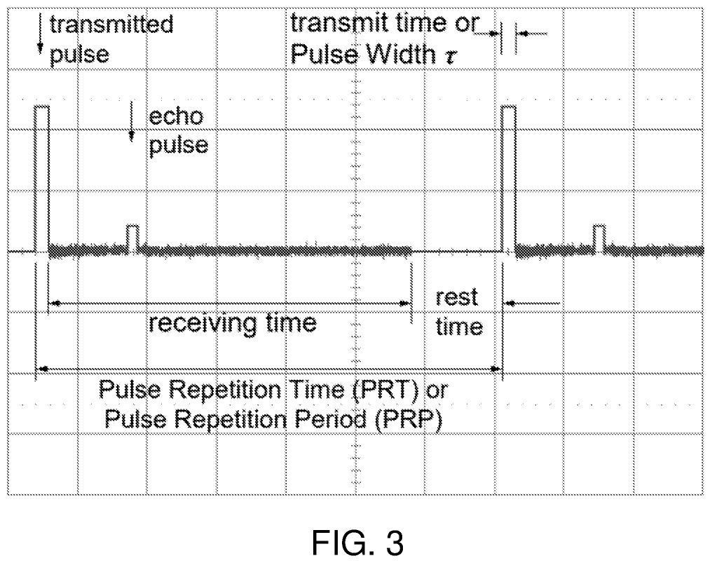

While the range resolution (ΔR) is calculated as:

$$Δ R = \frac{c τ}{2}$$

Where t is the pulse width and c is the speed of light. The radar pulses are usually transmitted periodically so that range information can be provided in real time and wait for the returning echo signal during the so-called rest/listening time, e.g., as seen by FIG. 3.

In this disclosure, solutions are discussed to facilitate data-aided radar sensing, where specific sensing tasks can be accomplished in parallel to the data communications. The following enhancements are introduced to facilitate the aforementioned task:
Sensing features are introduced to utilize the capability of the network for sensing during data communication that include
Enhancement of slot format indicator with joint symbol to allow Rx-and-sensing as well as Tx-for-sensing modes
Enabling sensing at the nodes and BWPs outside of the configured resources for the reception of data and control information
Dedicated measurements to identify proper links for monitoring/sensing
Measurements and reporting to facilitate the optimization of the transmit beam and waveform for the purpose of joint communication and radar sensing

In a first embodiment, sensing modes for communication resources are discussed. In addition to the defined data transmission modes, this embodiment defines additional operational modes for joint communication and sensing which enables the intended data-aided radar sensing task.

It is noted that the term ‘joint symbol’ indicates a symbol where a sensing operation is done simultaneously with an UL or DL communication. The reference to UE and gNB nodes can be viewed as an example of a generalized reference to a node in the network (node 1 or node 2), without being necessarily restricted to the NR framework.

In one embodiment, enhancements to slot format indicator for data-aided sensing are proposed. According to embodiment 1, the slot format for NR is enhanced to configure UEs with joint symbols that indicate the symbols where DL and/or UL communication can jointly happen with sensing or sidelink communication with sensing. These joint data aided sensing symbols may be in addition to the already NR defined UL, DL, and flexible symbols. In some embodiments, when a UE is configured/indicated with joint symbol, it can also expect to perform full-duplex operation. For example, it can transmit UL and simultaneously receive sensing signals transmitted by UE. In alternate embodiments, when a UE is configured/indicated with joint symbol, it is still expected to perform half-duplex operation. For example, the UE can receive DL and simultaneously receive sensing signals from the network. In some embodiments, the sensing, and data signals are the same. An example of this extension is given in Table 1, where S refers to the sensing symbols.

TABLE 1
Illustration of slot format indicator with joint sensing symbols

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U&S | U&S | U&S | U&S | U&S | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D&S | D&S | D&S | D&S | D&S | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | U&S | U&S | D&S | D&S | D&S | D | D | U | U | F | F | F | F | F |
| . . . | | | | | | | | | | | | | | |

In some embodiments, UE-specific signaling can be used to indicate slot format with joint symbols or a sub-set of symbols where joint communication and sensing can be performed. In one implementation, UE-specific DCI format such as format 0_1, 0_2, 1_1, 1_2 could be applied for indicating such information. When this UE-specific DCI format with joint symbol indication is received, it can overwrite the slot format that has been earlier configured by the network with common and/or dedicated SFI. In an alternate implementation, UE-specific RRC signaling is used to indicate joint symbol(s) to UE. In another implementation, MAC CE can be used to activate joint symbols when semi-statically a set of symbols are configured as joint symbols, but not used for joint communication and sensing until the activation is sent by MAC CE. Until MAC CE is received to activate joint symbols, the symbol configuration based on SFI indication/configuration is applied.

In some embodiments, the symbol types can be configured to a group of UEs which are relevant for a specific sensing task via a group common DCI (for example DCI format 2_0 or some new DCI format) or RRC signaling, in an implementation of the same embodiment, the modification of the UL and DL symbol types respectively to “U&S” and “D&S” can be signaled by indicating the starting symbol and the number of symbols to be switched to the corresponding sensing type.

In some embodiments, each UE can be configured with some of the symbols to be only sensing “S” via DCI or MAC CE and/or semi-static configuration via RRC. This indicates that there will be no data reception from that symbol.

In some embodiments, a guard period is expected while switching in following cases:
DL (or DL&S or S) to UL (or UL&S)
UL (or UL&S) to DL (or DL&S or S)

In some embodiments, a guard period is not expected in the following cases:
A switch between any of DL, DL&S, S
A switch between UL, UL&S

In some embodiments, the guard band length can be configured or mapped according to the difference between the numerology (SCS values) between the radar signal and UL/DL.

In one implementation, DL&S and DL could use different numerology e.g., SCS and needs guard symbol to switch between them for example, DL&S could use higher SCS compared to DL to aid the transmission/reception of radar signal. In another implementation, flexible symbol could be used for the transmission of radar signal alone. In another implementation, radar signal is transmitted within the CP duration of the DL signal.

In some embodiments, periodic joint symbols/slots can be configured/indicated to the UE from network. In one implementation, UE receives SFI indicating UL, DL and/or flexible symbols. Additionally, UE is configured to apply joint symbols to at least some of the UL, DL and/or flexible symbols and also a periodicity. This would allow to use UL/DL/flexible symbols as joint symbols in a periodic manner as configure by network. For example, if the periodicity of joint symbols is 10 ms and the duration is 14 symbols, then UE is expected to use 14 symbols after every 10 ms as joint symbols. Distributed sets of symbols with single or multiple periodicities for joint symbols can be configured to the UE.

In some embodiments, the activated sensing period at a receiver may overlap only partially with the transmission of the communication signals subject to sensing.

In some embodiment, UE could be configured semi-statically or dynamically with one or more standalone sensing RS transmission slots/occasions, time domain repetition, sensing bandwidth where sensing RS is transmitted/received, sensing beam(s) and corresponding PHY parameters such as SCS and CP. In one implementation, zadoff-chu sequence could be configured to be transmitted as sensing RS and which case base sequence length, cyclic shift, etc., could be semi-statically configured.

In a second implementation of the first embodiment, directed to sensing type configuration, in order to enable sensing together with UL and DL communications and considering different sensing requirements and processing capabilities at different candidate devices, different levels of sensing requirements can be defined. Sensing type can be configured via the sensing-confg-param, which provides:
a reference SCS configuration μ_{ref} by sensin_referenceSubcarrierSpacing;
a processing time window sensing_time-window-start, sensing_time-window-length;
a processing memory sensing_time-memory;
a sensing RB window sensing_RB-window-start, sensing_RB-window-length; and
a computational strategy number sensing processing idx,
where sensing_time-window-start and sensing_time-window-length identify the time window over which the received signal is used to perform sensing measurement via the computational strategy identified with sensing processing idx, the sensing_time-memory indicates the buffer length for the device to store the results of sensing measurement, sensing processing idx identifies the types of measurement output set which is expected, and may range from RSS calculation, blockage probability, to the detection of dynamic multi-path components.

An example numerology and different measurement processing types are depicted in Table 2 below. Please note that the choice of the measurement types depends on the available resources and processing capability at the UE, as well as the nature of the sensing scenario. For instance, the index “0” identifies the simplest type of sensing measurements when UE is required to measure and report the average received power. In other implementations, additional received signal strength metrics may also be considered, e.g., RSSI, RSRQ, RSRP. The sensing type with index “1”, requires UE to calculate the number of the drops in the span of the received power measurements, and perhaps infer the blockage probability value. Index “2” identifies the case where the sensing is conducted by calculating an estimate from the power delay profile and observing the appearance of a new reflection or a blockage event. Index “3” identifies the scenario where an arbitrary computational model is configured/transferred to the UE for the purpose of sensing measurements. Index “4” indicates sensing task for detecting and potentially extracting information from the response from a transponder device which is used for the purpose of blockage/mobility monitoring.

TABLE 2
Illustration of different sensing measurement types

| Index | Sensing measurement type |
|---|---|
| 0 | Received average signal power |
| 1 | Link blockage probability, average power |
| | drop occurrences |
| 2 | Power-delay profile-based blockage and |
| | multipath detection |
| 3 | Computation based on a configured |
| | learning model on a default model or on a |
| | model transferred to the UE |
| 4 | Detection of the transponder response |

The specific parameters for each sensing measurement type can be configured via dynamic DCI signaling as part of the sensing measurement report type for each sensing task, or semi-statically via RRC configuration for each device.

In some embodiments, the transmission subject to sensing may be configured to comply with some requirements to facilitate sensing at the sensing UE, e.g., avoiding fluctuations in the transmit waveform power.

In some embodiments, the sensing UE may be required to decode the received data before measurements related to sensing. In this case the decoded data can be utilized to act as a known reference signal to perform the required measurements in Table 2 with a higher resolution. In some embodiments, the sensing UE is configured to utilize the transmitted reference signals (e.g., demodulation reference signal (“DMRS”)) of any of the monitored links for the purpose of sensing.

In some embodiments, a sensing node is configured to store the received signal waveform for an indicated window of time and perform the sensing measurements upon further dynamic indication from the gNB.

In a third implementation of the first embodiment, directed to sensing data reporting, depending on the sensing type, the UE will perform measurements specifically related to sensing beams and report corresponding beams and results of the sensing measurements to the gNB.

In some embodiments, the UE is requested to report the monitoring link quality, in order to ensure a reliable sensing inference, e.g., if the link should be continued to be monitored or not. A link may become unreliable due to, e.g., mobility and loss of coverage in the sensing link.

In some embodiments, the reporting parameters are set differently for different sensing types. The reporting of a specific sensing outcome can be configured as periodic, dynamic, or UE-triggered. For example, in one implementation, the reporting of the link RSS can be configured to be periodically or dynamically, whereas the occurrence of a blockage with a high probability can be reported on the UE-triggered basis.

In some embodiments, the measurement report including sensing data may be event-triggered. An event can be defined based on certain configured criteria, e.g., link quality such received signal strength falls below a configured threshold, or the detection of a new multi-path component with a certain power or probability. Each event can be configured with exemplary parameters including hysteresis and threshold parameters for a certain event requiring immediate reporting of the sensing data.

In some embodiments, UE is requested to report the beam direction information used for sensing. In some embodiments, UE reports same beam for communication and sensing. In some alternate embodiments, UE reports at least two beams, wherein one beam is for communication and the other beam is for sensing. In some embodiments, UE reports beam(s) only for sensing purpose.

In a second embodiment of the proposed solution, directed to sensing BWPs and out-of-band sensing, a UE can be configured with up to four DL and up to four UL BWPs for each serving cell. Nevertheless, UEs shall support only one active BWP for reception and one for transmission. Moreover, the intended data transmission subject to the sensing task may differ in waveform numerology, e.g., SCS, with that of the configured active BWP for reception at the sensing node.

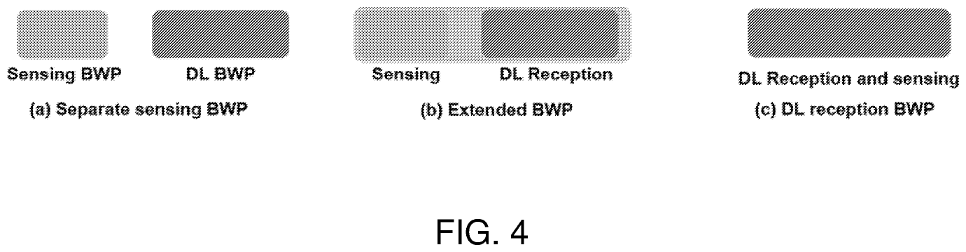

According to this embodiment, UEs may be enabled to perform sensing at the BWPs other than the active BWP configured for data reception. Furthermore, the requirements for data reception on the active BWP can be relaxed, depending on the requirements posed by the sensing type. This will expand the sensing task for the UEs which are positioned at a favorable location for sensing an active communication link, however, they are not configured with an active DL BWP at the related frequency range to facilitate sensing, please see FIG. 4 for the envisioned BWP configurations in this embodiment.

In one embodiment, the active BWP may be expanded to also cover the frequency location envisioned for sensing. This can be dynamically configured via DCI or semi-statically via RRC signaling.

In some embodiments, the UE may be configured to perform sensing within the configured active DL BWP configuration. One example is when the UE is sensing the environment via the same received DL channel containing data/control information.

In some embodiments, the UE may be enabled to perform some types of sensing tasks within the active or an extended active BWP, but with different SCS than that of the configured BWP. This can be enabled by additional time domain processing at the UE for specific sensing tasks. In one implementation, the UE may perform RSS measurements monitoring via time-domain processing on the specific part of the BWP envisioned for sensing, and subsequently filter and remove the content such that the remaining signal complies with the requirements of the envisioned DL BWP.

In some embodiments, UEs may be capable to be configured with sensing BWPs in a reduced-capability mode which poses minimal requirements on the baseband processing and the received waveform. This can be realized, e.g., via a hardware architecture to enable some sensing capabilities, relying on measurements in the RF domain. The related RF measurements will be then given to the digital processor. An example is when UE estimates RSS directly via RF measurements. In some embodiments, due to the reduced hardware and processing overhead, UEs may be enabled with multiple sensing BWPs simultaneously, other than the active BWP for data communication. Such capabilities may be signaled to the base station as part of the UECapabilityInformation message using RRC signaling.

In some embodiments, the configured BWP where sensing is taking place, may have only a partial (but non-zero) overlap with the bandwidth of the transmitted data (subject to sensing).

In some embodiments, the sensing BWPs can be configured/activated dynamically via DCI, periodically or semi-statically via RRC signaling.

In some embodiments, a group of UEs are configured to simultaneously perform some types of sensing tasks within the active or an extended active BWP or at the BWPs other than the active BWP configured for data reception. These UEs may be configured to perform these tasks either dynamically through group common DCI or through RRC signaling.

In some embodiments, UEs autonomously perform some types of sensing tasks within the active or an extended active BWP or at the BWPs other than the active BWP. The resources and configurations of tasks may be indicated by the network through RRC signaling. However, the UE only reports when some set threshold is not met. The reporting resources and their location/periodicity may be initially configured by the network.

A third embodiment of the proposed solution is directed to identifying proper links for monitoring using a construction of network line of sight (“LoS”) map. According to this embodiment, the proper links for monitoring will be chosen by the means of inference from the received signal at each communication link, or when necessary, by means of dedicated measurement procedures depending on the communication scenario and the gNB or UE capability.

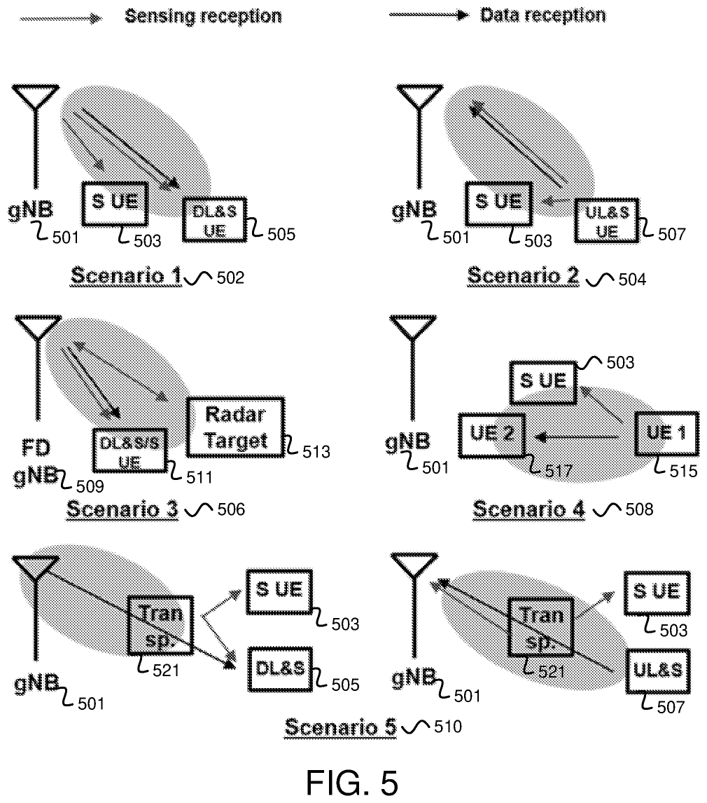

FIG. 5 depicts various link scenarios for joint communication and sensing. “S UE” denotes a UE which is enabled with sensing capability at the corresponding resource. “DL&S” and “UL&S” respectively represent the modes of UE jointly performing DL reception and sensing or performing UL transmission which is also intended to be used for sensing/link monitoring.

The data-aided sensing link scenarios, illustrated in FIG. 5, are described below.
Scenario 1 502: links between gNB 501 and UEs 503, 505 in the DL direction are monitored. The sensing task will be done either at the UE 505 with DL&S mode (the intended recipient of DL data) or at a third-party UE (potentially multiple UEs) configured in the sensing mode at the same resource.

In some embodiments, the determination of the gNB-S UE links can be done via dedicated measurements, employing R-RS/CSI-RS for link property (e.g., LoS) determination between the gNB 501 and the potential S UEs 503.

In some implementations, the determination of the gNB-S UE links can be done by configuring the potential S UEs 503 to measure the communication signals from the gNB 501.

In some embodiments, the determination of the proper links for the gNB-DL path can be done via observation of the received data at the DL UE 505.

In the previous embodiments, the dedicated measurements and sensing can be configured for a group of relevant (e.g., closely located) UEs with respect to a specific DL communication.
Scenario 2 504: a link between a UE 507 in UL&S mode and the gNB 501, as well as (potentially) the link between the same UL&S UE 507 and another or potentially multiple UEs enabled with sensing will be monitored.

In some embodiments, the determination of the UL&S-gNB links and the UL&S-S UE links for sensing can be done via dedicated measurements, employing R-RS/SRS for link property (e.g., LoS) determination.

In some implementations, the determination of the UL&S-S UE links can be done by configuring the potential S UEs 503 or a group of potential S UEs to measure the communication signals from the UL UE 507.

In the previous embodiments, the dedicated measurements and sensing can be configured for a group of relevant (e.g., closely located) S-UEs 503 with respect to a specific UL communication.
Scenario 3 506: a reflection link between an FD gNB 509 and the potential target location (reflection in case of existence of a blockage) 511, 513 and the paths between the gNB 509 and potentially other third-party DL users (enabled with sensing) will be monitored.

When gNB 509 is capable of FD operation, the reflections from the DL data transmissions can be used for observing/sensing potential radar target locations 513. The determination of the potential target locations/directions shall be apriori determined in gNB 509.
Scenario 4 508: In a sidelink communication scenario, a link between UE 1 515 and UE 2 517, as well as the links between UE 1 515 and the proper UEs 519 configured with sensing modes are monitored.

In some implementation, the determination of the UE 1-UE 2 links for sensing/monitoring can be done by means of UE 2 517 observing and measuring the received signal from UE 1 515. In some implementation, the determination of the UE 1-S UE links for monitoring can be done by means of S UEs 519 observing and measuring the received signal from UE 1 515 during UE 1-UE 2 communications. In this case the sensing UE 503 is configured to measure the power of the reflected SL data signal from a blockage. In another implementation, S UEs 503 measure the link properties by receiving reference signals for the intended UE1-UE2 communications (e.g., DMRS, PRS). In some implementation, the determination of the UE 1-S UE links for monitoring can be done by means of dedicated measurements via reference signals (SRS, R-RS) such that channel impulse response (“CIR”) can be estimated and used for the range/location estimation.
Scenario 5 510: In this scenario, a transponder device 521 (e.g., a device capable of transmission of a response with a known or a configurable delay upon reception of a proper trigger-signal, e.g., an active sensor node, a UE, a specific RFID card, and/or the like) is installed on the body of a potential moving blockage object and is used to identify the presence of a blockage. The signal from the transponder device 521 will be sensed by a sensing-capable device (e.g., UE 503, 505 or gNB 501). The observation/sensing of the response signal acts as a method for identifying the presence of the blockage object.

In some embodiments, the configuration of the sensing modes for UL&S 507, DL&S 505, and sensing UEs 503 shall be aligned with the provisioned/configured delay of the transponder response signal. That can be implemented with the configuration of the SFI in the first embodiment, where at least part of the sensing/joint symbols are positioned with the intended delay after the symbols envisioned to trigger the transponder device 521. In some embodiments, multiple adjacent sensing symbols shall be configured when the expected delay at the transponder device 521 is subject to uncertainty. In some embodiments, the configuration of the sensing modes for the transmission of the trigger signal and reception of the response symbol can be configured dynamically via DCI signaling, periodically, or semi statically via RRC signaling. In some embodiments, the configuration of the sensing modes for a group of favorably located sensing UEs 503 can be done jointly via a group common DCI or higher layer signaling. In some embodiments, an FD gNB 509 may also take part in the sensing of the response signal.

In some embodiments of the Scenarios 2 and 4 and 5, the transmitting UE may operate in FD mode, thereby observing the reflections from the environment or delayed reflections or partial reflections from the transponder device 521 for sensing. In this case, the FD UE acts both as the transmitter as well as the sensing device. In an embodiment, the gNB 501 may configure the UE to operate in FD mode for data transmission, for data reception, for transmission of sensing/radar reference signal, for sensing, or for a combination thereof. This shall be considered as an extension to the indicated sensing modes defined in the first embodiment. The configuration of the sensing modes for the FD UEs shall be done dynamically via DCI signaling, periodically, or semi statically via RRC signaling.

A fourth embodiment is directed to joint communication and sensing adjustments. According to this embodiment, upon determination of the proper paths for monitoring/sensing purposes, the communication and sensing parameters shall be jointly tuned. This is of significance due to the utilization of the communication resources for joint communication and sensing purposes.

For all scenarios explained above, the transmission beams shall be adjusted to provide sufficient coverage to the sensing nodes as well as to provide a sufficient reception quality at the intended communication receiver. This can be done by means of the transmission of proper reference signal in each case and the corresponding measurements. In some implementations, the beam adjustment procedure also includes interference measurements towards other information receivers. The interference measurements will be used such that the beam adjustments for sensing does not deteriorate the reception quality of the other co-existing communication links.

In some implementations, the S UEs can be configured to adjust their reception parameters (e.g., Rx beam) to maximize reception for link monitoring, during or after the initial LoS link determination phase.

The occurrence of a beam misalignment may be misrepresented as a blockage event, depending on the level of the configured sensing. In order to recover from this, in some embodiments, UEs may be configured to perform some active measures, e.g., beam widening, beam sweeping, simultaneous multiple beams, reporting the beam direction information when detecting a blockage, to resolve the confusion.

In some embodiments, after the determination of a link for sensing/monitoring, the transmit waveform parameters, e.g., SCS, can be dynamically adjusted in order to enhance sensing capability. For example, to extend the coverage and get higher reflected power from a potential blockage, SCS can be reduced, e.g., from 960 KHz to 120 KHz to have longer symbols. In an embodiment, upon determination of an LoS link for sensing, a higher order SCS shall be used to improve sensing resolution.

In some embodiments, when a UE operating in UL&S mode employs a wide beam in order to enable sensing for a group of S UE, it can be configured to adjust its transmit power to accordingly compensate for the coverage reduction in the communication link. In some embodiments, the UEs performing a sensing task are configured with multiple beams for sensing for simultaneous measurements.

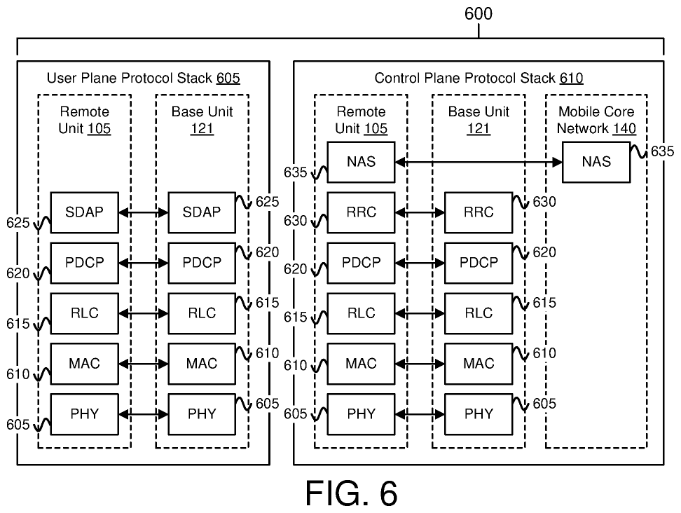

FIG. 6 depicts a NR protocol stack 600, according to embodiments of the disclosure. While FIG. 6 shows the remote unit 105, the base unit 121 and the mobile core network 130, these are representative of a set of UEs interacting with a RAN node and a NF (e.g., AMF) in a core network. As depicted, the protocol stack 600 comprises a User Plane protocol stack 605 and a Control Plane protocol stack 610. The User Plane protocol stack 605 includes a physical (“PHY”) layer 615, a Medium Access Control (“MAC”) sublayer 620, a Radio Link Control (“RLC”) sublayer 625, a Packet Data Convergence Protocol (“PDCP”) sublayer 630, and Service Data Adaptation Protocol (“SDAP”) layer 635. The Control Plane protocol stack 610 also includes a physical layer 615, a MAC sublayer 620, a RLC sublayer 625, and a PDCP sublayer 630. The Control Place protocol stack 610 also includes a Radio Resource Control (“RRC”) layer and a Non-Access Stratum (“NAS”) layer 645.

The AS protocol stack for the Control Plane protocol stack 610 consists of at least RRC, PDCP, RLC and MAC sublayers, and the physical layer. The AS protocol stack for the User Plane protocol stack 605 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 640 and the NAS layer 645 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 615 offers transport channels to the MAC sublayer 620. The MAC sublayer 620 offers logical channels to the RLC sublayer 625. The RLC sublayer 625 offers RLC channels to the PDCP sublayer 630. The PDCP sublayer 630 offers radio bearers to the SDAP sublayer 635 and/or RRC layer 640. The SDAP sublayer 635 offers QoS flows to the mobile core network 130 (e.g., 5GC). The RRC layer 640 provides for the addition, modification, and release of Carrier Aggregation and/or Dual Connectivity. The RRC layer 640 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

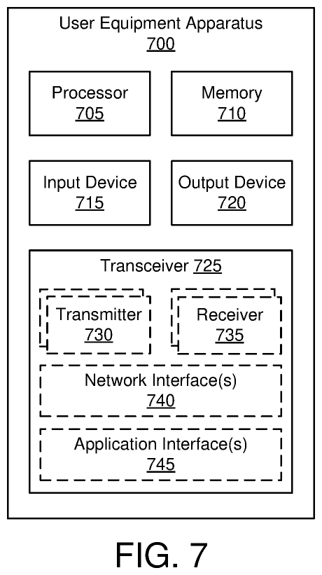

FIG. 7 depicts a user equipment apparatus 700 that may be used for data-aided radar sensing, according to embodiments of the disclosure. In various embodiments, the user equipment apparatus 700 is used to implement one or more of the solutions described above. The user equipment apparatus 700 may be one embodiment of a UE, such as the remote unit 105 and/or the UE 205, as described above. Furthermore, the user equipment apparatus 700 may include a processor 705, a memory 710, an input device 715, an output device 720, and a transceiver 725. In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more base units 121. Additionally, the transceiver 725 may support at least one network interface 740 and/or application interface 745. The application interface(s) 745 may support one or more APIs. The network interface(s) 740 may support 3GPP reference points, such as Uu and PC5. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to CSI enhancements for higher frequencies. For example, the memory 710 may store parameters, configurations, resource assignments, policies, and the like as described above. In certain embodiments, the memory 710 also stores program code and related data, such as an operating system or other controller algorithms operating on the user equipment apparatus 700, and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. The transceiver 725 may be used to provide UL communication signals to a base unit 121 and to receive DL communication signals from the base unit 121, as described herein. Similarly, the transceiver 725 may be used to transmit and receive SL signals (e.g., V2X communication), as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an ASIC, or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

In one embodiment, the transceiver 725 receives, from a second network node, a first configuration comprising an indication of at least one set of time-frequency resources on which the first network node is to perform at least one of a sensing measurement and a sensing measurement jointly with reception of one of data and control information and receives, from the second network node, a second configuration comprising an indication of a sensing measurement type to be applied on the at least one set of time-frequency resources identified with sensing. In one embodiment, the processor 705 conducts sensing measurements according to the first and second configurations. In one embodiment, the transceiver transmits a report from the conducted sensing measurements to the second network node.

In one embodiment, the second configuration of sensing measurement type comprises at least one of an indication of a waveform type for sensing measurement, an indication of a computational strategy, and an indication of a sensing memory.

In one embodiment, the processor 705 performs a sensing measurement jointly with information reception on the at least one set of time-frequency resources, decodes the received information, and uses the decoded sequence as a reference signal as part of the indicated sensing measurements.

In one embodiment, the processor 705 performs a sensing task on the at least one set of time-frequency resources coexisting with the transmission of the second network node and the transceiver transmits a configuration to the second network node for adjusting the second network node's transmission parameters to assist the sensing measurements by the first network node.

In one embodiment, the processor 705 configures sensing modes for the first network node on the at least one set of time-frequency resources together with an indication of a time domain behavior, including at least one of a one-time, a periodic, and a semi-persistent configuration.

In one embodiment, the transceiver 725 receives a configuration from the second network node for performing beam measurements for one or more of communication with and sensing from one or more of the second network node and a third network node.

In one embodiment, the transceiver 725 receives a configuration from the second network node with one or more of a first beam for sensing and information reception, a second beam for information reception, a third beam for information transmission where the transmission is used for sensing at a network node, a fourth beam for sensing, and a fifth beam for information transmission.

In one embodiment, the transceiver 725 receives a configuration from the second network node with one or more of a first waveform for sensing and information reception, a second waveform for information reception, a third waveform for information transmission where the transmission is used for sensing at a network node, a fourth waveform for sensing, a fifth waveform for information transmission, and a six waveform for information transmission and reception.

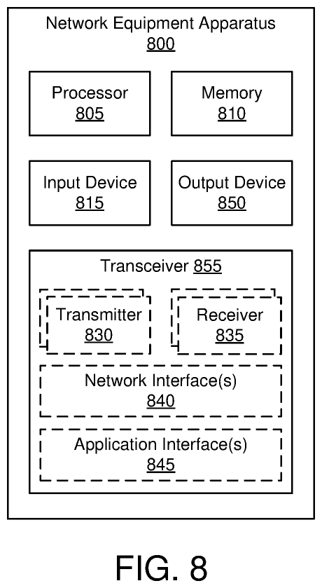

FIG. 8 depicts one embodiment of a network apparatus 800 that may be used for data-aided radar sensing, according to embodiments of the disclosure. In some embodiments, the network apparatus 800 may be one embodiment of a RAN node and its supporting hardware, such as the base unit 121 and/or gNB, described above. Furthermore, network apparatus 800 may include a processor 805, a memory 810, an input device 815, an output device 820, and a transceiver 825. In certain embodiments, the network apparatus 800 does not include any input device 815 and/or output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2, N3, N5, N6 and/or N7 interfaces. Other network interfaces 840 may be supported, as understood by one of ordinary skill in the art.

When implementing an NEF, the network interface(s) 840 may include an interface for communicating with an application function (i.e., N5) and with at least one network function (e.g., UDR, SFC function, UPF) in a mobile communication network, such as the mobile core network 130.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825. In certain embodiments, the processor 805 may include an application processor (also known as “main processor”) which manages application-domain and operating system (“OS”) functions and a baseband processor (also known as “baseband radio processor”) which manages radio function. In various embodiments, the processor 805 controls the network apparatus 800 to implement the above described network entity behaviors (e.g., of the gNB) for data-aided radar sensing.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data relating to CSI enhancements for higher frequencies. For example, the memory 810 may store parameters, configurations, resource assignments, policies, and the like as described above. In certain embodiments, the memory 810 also stores program code and related data, such as an operating system (“OS”) or other controller algorithms operating on the network apparatus 800, and one or more software applications.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, may include any known electronically controllable display or display device. The output device 820 may be designed to output visual, audible, and/or haptic signals. In some embodiments, the output device 820 includes an electronic display capable of outputting visual data to a user. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, all or portions of the output device 820 may be located near the input device 815.

As discussed above, the transceiver 825 may communicate with one or more remote units and/or with one or more interworking functions that provide access to one or more PLMNs. The transceiver 825 may also communicate with one or more network functions (e.g., in the mobile core network 80). The transceiver 825 operates under the control of the processor 805 to transmit messages, data, and other signals and also to receive messages, data, and other signals. For example, the processor 805 may selectively activate the transceiver (or portions thereof) at particular times in order to send and receive messages.

The transceiver 825 may include one or more transmitters 830 and one or more receivers 835. In certain embodiments, the one or more transmitters 830 and/or the one or more receivers 835 may share transceiver hardware and/or circuitry. For example, the one or more transmitters 830 and/or the one or more receivers 835 may share antenna(s), antenna tuner(s), amplifier(s), filter(s), oscillator(s), mixer(s), modulator/demodulator(s), power supply, and the like. In one embodiment, the transceiver 825 implements multiple logical transceivers using different communication protocols or protocol stacks, while using common physical hardware.

In one embodiment, the transceiver 825 transmits, to a first network node, a first configuration comprising an indication of at least one set of time-frequency resources on which the first network node is to perform at least one of a sensing measurement and a sensing measurement jointly with reception of one of data and control information, transmits, to the first network node, a second configuration comprising an indication of a sensing measurement type to be applied on the at least one set of time-frequency resources identified with sensing, and receives, from the first network node, a report from the conducted sensing measurements.

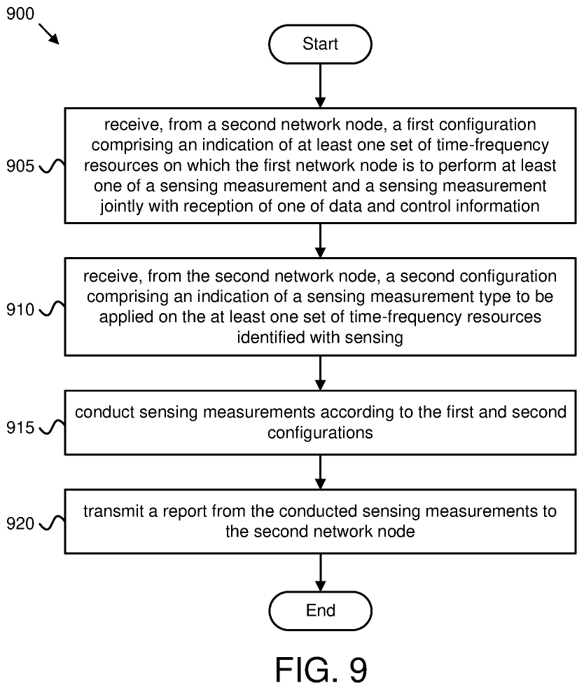

FIG. 9 is a flowchart diagram of a method 900 for data-aided radar sensing. The method 900 may be performed by a UE as described herein, for example, the remote unit 105 and/or the user equipment apparatus 700. In some embodiments, the method 900 may be performed by a processor executing program code, for example, a microcontroller, a microprocessor, a CPU, a GPU, an auxiliary processing unit, a FPGA, or the like.

In one embodiment, the method 900 begins and receives 905, from a second network node, a first configuration comprising an indication of at least one set of time-frequency resources on which the first network node is to perform at least one of a sensing measurement and a sensing measurement jointly with reception of one of data and control information. In one embodiment, the method 900 receives 910, from the second network node, a second configuration comprising an indication of a sensing measurement type to be applied on the at least one set of time-frequency resources identified with sensing. In one embodiment, the method 900 conducts 915 sensing measurements according to the first and second configurations. In one embodiment, the method 900 transmits 920 a report from the conducted sensing measurements to the second network node, and the method 900 ends.

A first apparatus is disclosed for data-aided radar sensing. The first apparatus may include a UE as described herein, for example, the remote unit 105 and/or the user equipment apparatus 700. In some embodiments, the first apparatus may include a processor executing program code, for example, a microcontroller, a microprocessor, a CPU, a GPU, an auxiliary processing unit, a FPGA, or the like.

In one embodiment, the first apparatus includes a transceiver that receives, from a second network node, a first configuration comprising an indication of at least one set of time-frequency resources on which the first network node is to perform at least one of a sensing measurement and a sensing measurement jointly with reception of one of data and control information and receives, from the second network node, a second configuration comprising an indication of a sensing measurement type to be applied on the at least one set of time-frequency resources identified with sensing. In one embodiment, the first apparatus includes a processor that conducts sensing measurements according to the first and second configurations. In one embodiment, the transceiver transmits a report from the conducted sensing measurements to the second network node.

In one embodiment, the second configuration of sensing measurement type comprises at least one of an indication of a waveform type for sensing measurement, an indication of a computational strategy, and an indication of a sensing memory.

In one embodiment, the processor performs a sensing measurement jointly with information reception on the at least one set of time-frequency resources, decodes the received information, and uses the decoded sequence as a reference signal as part of the indicated sensing measurements.

In one embodiment, the processor performs a sensing task on the at least one set of time-frequency resources coexisting with the transmission of the second network node and the transceiver transmits a configuration to the second network node for adjusting the second network node's transmission parameters to assist the sensing measurements by the first network node.

In one embodiment, the processor configures sensing modes for the first network node on the at least one set of time-frequency resources together with an indication of a time domain behavior, including at least one of a one-time, a periodic, and a semi-persistent configuration.

In one embodiment, the transceiver receives a configuration from the second network node for performing beam measurements for one or more of communication with and sensing from one or more of the second network node and a third network node.

In one embodiment, the transceiver receives a configuration from the second network node with one or more of a first beam for sensing and information reception, a second beam for information reception, a third beam for information transmission where the transmission is used for sensing at a network node, a fourth beam for sensing, and a fifth beam for information transmission.

In one embodiment, the transceiver receives a configuration from the second network node with one or more of a first waveform for sensing and information reception, a second waveform for information reception, a third waveform for information transmission where the transmission is used for sensing at a network node, a fourth waveform for sensing, a fifth waveform for information transmission, and a six waveform for information transmission and reception.

A first method is disclosed for data-aided radar sensing. The first method may be performed by a UE as described herein, for example, the remote unit 105 and/or the user equipment apparatus 700. In some embodiments, the first apparatus may include a processor executing program code, for example, a microcontroller, a microprocessor, a CPU, a GPU, an auxiliary processing unit, a FPGA, or the like.

In one embodiment, the first method receives, from a second network node, a first configuration comprising an indication of at least one set of time-frequency resources on which the first network node is to perform at least one of a sensing measurement and a sensing measurement jointly with reception of one of data and control information and receives, from the second network node, a second configuration comprising an indication of a sensing measurement type to be applied on the at least one set of time-frequency resources identified with sensing. In one embodiment, the first method conducts sensing measurements according to the first and second configurations. In one embodiment, the first method transmits a report from the conducted sensing measurements to the second network node.

In one embodiment, the second configuration of sensing measurement type comprises at least one of an indication of a waveform type for sensing measurement, an indication of a computational strategy, and an indication of a sensing memory.

In one embodiment, the first method performs a sensing measurement jointly with information reception on the at least one set of time-frequency resources, decodes the received information, and uses the decoded sequence as a reference signal as part of the indicated sensing measurements.

In one embodiment, the first method performs a sensing task on the at least one set of time-frequency resources coexisting with the transmission of the second network node and the transceiver transmits a configuration to the second network node for adjusting the second network node's transmission parameters to assist the sensing measurements by the first network node.

In one embodiment, the first method configures sensing modes for the first network node on the at least one set of time-frequency resources together with an indication of a time domain behavior, including at least one of a one-time, a periodic, and a semi-persistent configuration.

In one embodiment, the first method receives a configuration from the second network node for performing beam measurements for one or more of communication with and sensing from one or more of the second network node and a third network node.

In one embodiment, the first method receives a configuration from the second network node with one or more of a first beam for sensing and information reception, a second beam for information reception, a third beam for information transmission where the transmission is used for sensing at a network node, a fourth beam for sensing, and a fifth beam for information transmission.

In one embodiment, the first method receives a configuration from the second network node with one or more of a first waveform for sensing and information reception, a second waveform for information reception, a third waveform for information transmission where the transmission is used for sensing at a network node, a fourth waveform for sensing, a fifth waveform for information transmission, and a six waveform for information transmission and reception.

A second apparatus is disclosed for data-aided radar sensing. The second apparatus may include a network node as described herein, for example, the base unit 121 and/or the network equipment apparatus 800. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver that transmits, to a first network node, a first configuration comprising an indication of at least one set of time-frequency resources on which the first network node is to perform at least one of a sensing measurement and a sensing measurement jointly with reception of one of data and control information, transmits, to the first network node, a second configuration comprising an indication of a sensing measurement type to be applied on the at least one set of time-frequency resources identified with sensing, and receives, from the first network node, a report from the conducted sensing measurements.

A second method is disclosed for data-aided radar sensing. The second method may be performed by a network node as described herein, for example, the base unit 121 and/or the network equipment apparatus 800. In some embodiments, the second method may be performed by a processor executing program code, for example, a microcontroller, a microprocessor, a CPU, a GPU, an auxiliary processing unit, a FPGA, or the like.

In one embodiment, the second method transmits, to a first network node, a first configuration comprising an indication of at least one set of time-frequency resources on which the first network node is to perform at least one of a sensing measurement and a sensing measurement jointly with reception of one of data and control information, transmits, to the first network node, a second configuration comprising an indication of a sensing measurement type to be applied on the at least one set of time-frequency resources identified with sensing, and receives, from the first network node, a report from the conducted sensing measurements.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network equipment (NE) for wireless communication, comprising:
at least one memory; and
at least one processor coupled with the at least one memory and configured to cause the NE to:
receives a first configuration comprising an indication of at least one set of time-frequency resources;
receives a second configuration comprising an indication of a type of sensing to perform on the at least one set of time-frequency resources;
perform sensing according to the first configuration and the second configuration; and
transmit a report that indicates one or more sensing measurements based on the performed sensing.

2. The NE of claim 1, wherein the second configuration comprises an indication of a waveform type for sensing, an indication of a computational strategy, an indication of a sensing memory, or a combination thereof.

3. The NE of claim 1, wherein the at least one processor is configured to cause the NE to perform sensing jointly with information received on the at least one set of time-frequency resources, decode the received information, and uses a sequence decoded from the received information as a reference signal for part of the sensing.

4. The NE of claim 1, wherein the at least one processor is configured to cause the NE to perform a sensing task on the at least one set of time-frequency resources that coexist with transmissions for a network node and transmit a third configuration to the network node for adjusting transmission parameters to assist the sensing by the NE.

5. The NE of claim 1, wherein the at least one processor is configured to cause the NE to configure sensing modes on the at least one set of time-frequency resources together with an indication of a time domain behavior, including a one-time configuration, a periodic configuration, or a semi-persistent configuration.

6. The NE of claim 1, wherein the at least one processor is configured to cause the NE to receive a third configuration for performing beam measurements for communication with or sensing from one or more network nodes.

7. The NE of claim 1, wherein the at least one processor is configured to cause the NE to receive a configuration from a network node with one or more of a first beam for sensing and information reception, a second beam for information reception, a third beam for information transmission where the transmission is used for sensing at the network node, a fourth beam for sensing, and a fifth beam for information transmission.

8. The NE of claim 1, wherein the at least one processor is configured to cause the NE to receive a configuration from a network node with one or more of a first waveform for sensing and information reception, a second waveform for information reception, a third waveform for information transmission where the transmission is used for sensing at the network node, a fourth waveform for sensing, a fifth waveform for information transmission, and a six waveform for information transmission and reception.

9. A method performed by a network equipment (NE), the method comprising:
receiving a first configuration comprising an indication of at least one set of time-frequency resources for sensing;
receiving a second configuration comprising an indication of a type of sensing to perform on the at least one set of time-frequency resources;
performing sensing according to the first configuration and the second configuration; and
transmitting a report that indicates one or more sensing measurements based on the performed sensing.

10. The method of claim 9, wherein the second configuration comprises an indication of a waveform type for sensing, an indication of a computational strategy, an indication of a sensing memory, or a combination thereof.

11. The method of claim 9, further comprising performing sensing jointly with information received on the at least one set of time-frequency resources, decoding the received information, and using a sequence decoded from the received information as a reference signal for part of the sensing.

12. The method of claim 9, further comprising performing a sensing task on the at least one set of time-frequency resources that coexist with transmissions for a network node and transmitting a third configuration to the network node for adjusting transmission parameters to assist the sensing by the NE.

13. The method of claim 9, further comprising configuring sensing modes on the at least one set of time-frequency resources together with an indication of a time domain behavior, including a one-time configuration, a periodic configuration, or a semi-persistent configuration.

14. The method of claim 9, further comprising receiving a third configuration for performing beam measurements for communication with or sensing from one or more network nodes.

15. A network equipment (NE) for wireless communication, comprising:
at least one memory; and
at least one processor coupled with the at least one memory and configured to cause the NE to:
transmits a first configuration comprising an indication of at least one set of time-frequency resources for sensing;
transmits a second configuration comprising an indication of a type of sensing to perform on the at least one set of time-frequency resources; and
receives a report that indicates one or more sensing measurements based on performed sensing.

16. A processor for wireless communication, comprising:
at least one controller coupled with at least one memory and configured to cause the processor to:
receive a first configuration comprising an indication of at least one set of time-frequency resources for sensing;
receive a second configuration comprising an indication of a type of sensing to perform on the at least one set of time-frequency resources;
perform sensing according to the first configuration and the second configuration; and
transmit a report that indicates one or more sensing measurements based on the performed sensing.

17. The processor of claim 16, wherein the second configuration comprises an indication of a waveform type for sensing, an indication of a computational strategy, an indication of a sensing memory, or a combination thereof.

18. The processor of claim 16, wherein the at least one controller is configured to cause the processor to perform sensing jointly with information received on the at least one set of time-frequency resources, decode the received information, and use a sequence decoded from the received information as a reference signal for part of the sensing.

19. The processor of claim 16, wherein the at least one controller is configured to cause the processor to perform a sensing task on the at least one set of time-frequency resources that coexist with transmissions for a network node and transmit a third configuration to the network node for adjusting transmission parameters to assist the sensing by the processor.

20. The processor of claim 16, wherein the at least one controller is configured to cause the processor to configure sensing modes on the at least one set of time-frequency resources together with an indication of a time domain behavior, including a one-time configuration, a periodic configuration, or a semi-persistent configuration.
